(19) United States
(12) Patent Application Publication
(10) Pub. No.: US 2013/0160896 A1
(43) Pub. Date: Jun. 27, 2013

(54) CERIUM BASED PERMANENT MAGNET MATERIAL

(71) Applicant: GM GLOBAL TECHNOLOGY OPERATIONS LLC, DETROIT, MI (US)

(72) Inventors: ERIC J. SKOUG, Portland, OR (US); MARTIN S. MEYER, SOUTHFIELD, MI (US); JAN F. HERBST, GROSSE POINTE WOODS, MI (US); FREDERICK E. PINKERTON, SHELBY TOWNSHIP, MI (US)

(73) Assignee: GM GLOBAL TECHNOLOGY OPERATIONS LLC, DETROIT, MI (US)

(21) Appl. No.: 13/773,935

(22) Filed: Feb. 22, 2013

Related U.S. Application Data
(63) Continuation-in-part of application No. 13/367,427, filed on Feb. 7, 2012.
(60) Provisional application No. 61/485,156, filed on May 12, 2011.

(51) Int. Cl. H01F 1/053

(52) U.S. Cl. CPC H01F 1/053
USPC 148/101; 148/302

(57) ABSTRACT

Useful permanent magnet materials are formed by processing molten alloys of cerium, iron, and boron to form permanent magnet compositions with appreciable coercivity and remanence. For example, Ce_{16.7}Fe_{77.8}B_{5.6} has been produced with coercivity, H_{ci} of 6.18 kOe and remanence, Bᵣ of 4.92 kG. In a preferred practice, streams of the molten alloy are rapidly quenched (e.g., by melt spinning) to form magnetically-soft melt-spun material which is suitably annealed to obtain permanent magnet properties. Cobalt may be substituted for a portion of the iron content to increase the Curie temperature of the permanent magnet material. The rapid quench-anneal process is conducted to produce a fine-grain crystalline microstructure containing the Ce₂(Fe,Co)₁₄B phase in an amount of about seventy to ninety-five mass percent of the composition with a suitable amount of one or more secondary phases.

This application is a Continuation-in-Part of co-pending application Ser. No. 13/367,427, titled “Cerium Based Permanent Magnet Material”, filed Feb. 7, 2012, and assigned to the assignee of this invention, the contents of which are incorporated herein by reference. Application No. 13/367,427 in turn claims priority based on provisional application 61/485156, titled “Cerium Based Permanent Magnet Material,” and filed May 12, 2011.

### TECHNICAL FIELD

This invention pertains to rare earth-iron-boron permanent magnets. More specifically, this invention pertains to cerium-iron-boron permanent magnets and to cerium-iron-cobalt-boron permanent magnets.

### BACKGROUND OF THE INVENTION

Melt-spun neodymium-iron-boron magnets were invented by General Motors researchers in the early 1980s and subsequently commercialized by General Motors. The hard magnetic properties stem from the anisotropic crystal structure of the Nd₂Fe₁₄B compound, when melt quenched into a nanocrystalline microstructure together with a small amount of Nd-rich grain boundary phase. At that time the magnetic properties of melt-spun Ce—Fe—B were briefly explored, specifically at the same composition yielding optimum Nd—Fe—B material. However, owing to the superior magnetic properties of Nd—Fe—B, work was then directed to the neodymium-containing compositions. Rare earth-iron-boron magnets based on the ternary phase Nd₂Fe₁₄B remain today the best permanent magnets with energy products that can exceed 50 MGOe.

Renewed interest in Ce—Fe—B magnet materials has been stimulated by recent developments in rare earth supply and price. Nd is expensive, and furthermore Nd—Fe—B magnets are often modified with other rare earth additives such as Pr, Dy, Tb, or mixtures thereof, that enhance the magnetic properties. However, Pr, Dy, and Tb are also expensive, plus Dy and Tb constitute only a very small portion (˜2%) of a typical rare earth containing ore. Recently concerns have arisen about the future cost and availability of rare earths, particularly Nd, Pr, Dy, and Tb.

Samarium-cobalt permanent magnets have high energy product, but samarium is very expensive, and cobalt is more expensive than iron.

Ferrite magnets are inexpensive, but have limited magnetic properties.

Permanent magnets are used in electric motors, especially traction motors, and generators. Consequently there is an arising need for an alternative R—Fe—B magnet material based on the less expensive, more available rare earth Ce, while still retaining acceptable permanent magnet qualities.

### SUMMARY OF THE INVENTION

Early studies of melt-spun Ce—Fe—B ribbon materials produced optimum quenched permanent magnet compositions with remanence values, Bᵣ, of only 3.4 kG, and coercivity values of H_{ci}=2.5 kOe. In accordance with practices of this invention, magnetic properties of homogeneous powder compositions of the Ce—Fe—B system have been improved to achieve Bᵣ of about 5.3 kG and H_{ci} of up to 7.1 kOe (but not necessarily both values in a specific Ce—Fe—B composition). Many melt-spun and annealed Ce—Fe—B compositions have been produced in selected molar proportions yielding permanent magnets with coercivity values (H_{ci}, in kOe) and remanence values (Bᵣ, in kG) where the sums of the numerical values of H_{ci}, and Bᵣ are equal to 8 or greater. And in many rapidly-solidified and annealed compositions the sums of the H_{ci} and Bᵣ values exceed 9. Ce—Fe—B permanent magnet compositions have a relatively low Curie temperature (T_{c}) of 425K (152° C.). As will be discussed further in this specification, the Curie temperature may be increased by the substitution of cobalt for a portion of the iron content but with some reduction in other permanent magnet properties.

The crystalline microstructure of cerium-iron-boron permanent magnets is characterized by the presence of a Ce₂Fe₁₄B type phase and a CeFe₂ type phase, and sometimes by the presence of small amounts of Ce₂Fe₁₇ and Fe phases. In accordance with practices of this invention, it is preferred to prepare rapidly solidified and annealed powder particles of selected compositions that have microstructures characterized by at least seventy mass percent of the Ce₂Fe₁₄B phase in a mixture with the CeFe₂ phase or other secondary phase. Small amounts of the Ce₂Fe₁₇ and Fe phases may be present. While the permanent magnet properties of the material are attributable to the 2-14-1 crystal phase, the presence of a secondary phase is deemed necessary, for example, to impede domain wall motion.

Preferred permanent magnet microstructures contain about 70 mass percent to 95 mass percent of the Ce₂Fe₁₄B phase or Ce₂(Fe₁₄₋ₓ,Coₓ)B phase and about 4 mass percent to 27 mass percent of the CeFe₂ phase or Ce(Fe, Co)₂ phase. Small amounts of the Ce₂Fe₁₇ or Ce₂(Fe, Co)₁₇ phase and Fe or Co phases may be present in the microstructure. These phase quantities may be determined for example from analyses of X-ray diffraction patterns of powder samples of the permanent magnet materials. The Rietveld refinement technique may be used to determine the microstructure phase quantities from the x-ray patterns of the cerium based permanent magnet materials.

In general, the compositions of the magnetic materials are presented in this specification as CeₐFe_{b}B_{c}, where a, b, and c are molar (atomic) values whose sum, (a+b+c), can be normalized to 100 to facilitate placement of the composition on a ternary phase diagram. For example, as described below in this text, a composition, Ce_{16.7}Fe_{77.8}B_{5.6} (which can be written equivalently as Ce₃Fe₁₄B, the notation we actually used to specify the starting composition), has been prepared in powder form by a rapid-solidification and anneal process and found to have a combination of useful values of intrinsic coercivity, H_{ci} and of remanence, Bᵣ. It is recognized that these useful magnetic properties are the result of the presence of fine grains of the Ce₂Fe₁₄B phase in combination with one or more secondary phases. So when samples have been prepared in which cobalt is substituted for a portion of the iron in a specific composition, the resulting Ce₂Fe₁₄B-type phase is presented in terms of Fe₁₄₋ₓCoₓ content or as Ce₂Fe₁₄₋ₓCoₓB.

In accordance with preferred embodiments of this invention, the cerium-iron-boron materials are initially prepared as a melt, protected under a non-oxidizing atmosphere. In the preferred practice of the invention, the melt is quenched, or otherwise rapidly solidified (e.g., by melt spinning), to form particles of generally amorphous, soft magnet precursor materials. Particles of the soft magnet material are then, comminuted and annealed to form permanent magnet powder, which may be bonded or sintered into permanent magnet shapes and magnetized for many applications. The annealing temperature typically varies among individual cerium-iron-boron compositions, and a preferred annealing temperature for best permanent magnet properties may be found for each cerium-iron-boron or cerium-iron-cobalt-boron composition.

Melt spun and carefully annealed Ce_{16.7}Fe_{77.8}B_{5.6} has been produced with an intrinsic coercivity, H_{ci} of 6.18 kOe and remanence, Bᵣ of 4.92 kG. Similarly, Ce_{14.3}Fe_{78.6}B_{7.1} (equivalently, Ce_{2.55}Fe₁₄B_{1.27}) has been produced with coercivity, H_{ci} of 5.43 kOe and remanence, Bᵣ of 5.33 kG. Other rapidly solidified and annealed Ce—Fe—B compositions that have good permanent magnet properties include Ce_{15.4}Fe_{76.0}B_{7.7}, Ce_{17.0}Fe_{77.9}B_{4.2}, Ce_{22.8}Fe_{71.1}B_{6.1}, Ce_{14.4}Fe_{74.0}B_{10.7}, Ce_{18.2}Fe_{72.7}B_{0.1}, Ce_{21.1}Fe_{73.7}B_{5.3}, Ce_{13.3}Fe_{80.0}B_{6.7}, Ce_{18.5}Fe_{70.0}B_{11.5}, and Ce_{23.1}Fe_{73.5}B_{3.4}. Magnetic properties for these compositions are summarized in Table I presented below in this specification. It is seen that the highest values of both H_{ci} and Bᵣ are not found simultaneously in any single Ce—Fe—B composition.

In another practice of the invention, the molten alloy is quenched at a predetermined quench rate, such as at a predetermined melt-spinning quench wheel speed, to directly produce CeₐFe_{b}B_{c} permanent magnet material. In this direct quench method the material usually does not require an anneal to produce its permanent magnet properties. For example, direct quenched Ce_{16.7}Fe_{77.8}B_{5.6} has been produced with an intrinsic coercivity, H_{ci} of 5.32 kOe and remanence, Bᵣ of 5.19 kG. The direct quench particles may, for example, be ball milled to a desired particle size and resin bonded or hot compacted into a magnet body of desired shape.

It is preferred to prepare these cerium-containing magnetic materials by a process of rapid-solidification followed by a anneal to a selected temperature to produce a powdered material with particles of like dimensions in all directions and having a crystalline microstructure characterized by a mass percentage of about 70% to about 95% of the primary Ce₂Fe₁₄₋ₓCoₓB phase and one or more secondary phases, such as the Ce (Fe, Co)₂ phase, to inhibit domain wall motion in the primary phase.

Other objects and advantages of the invention will be apparent from a description of illustrative embodiments which follows in this specification.

### BRIEF DESCRIPTION OF THE DRAWINGS

FIG. 1 is a section of an equilibrium Ce—Fe—B phase diagram indicating starting compositions investigated in studies presented in this specification. The labels correspond to the entries in Table I, and the small squares are shaded on a gray scale for (Bᵣ+H.) ranging from black (smallest values) to white (largest values). This figure illustrates relative compositions but does not illustrate the proportions of crystalline phases in a rapidly solidified and annealed composition.

FIG. 2 is a graph of values for Bᵣ, Hₘ, and (BH)ₘₐₓ after heat treatment for 5 minutes at various temperatures for the Ce_{16.7}Fe_{77.8}B_{5.6} sample (Sample A) of Table I.

FIG. 3 presents Cu Ka x-ray diffraction diagrams for (a) as-spun and (b) heat treated Ce_{16.7}Fe_{77.8}B_{5.6}. The unlabeled peaks are Ce₂Fe₁₄B, the primary constituent in (b).

FIG. 4 is the room temperature demagnetization curve for heat treated Ce_{16.7}Fe_{77.8}B_{5.6} (Sample A in Table I).

FIG. 5 is a graph of the varying magnetic properties (Y-axis) of five melts of Ce_{16.7}Fe_{77.8}B_{5.6} composition quenched on a chromium-plated copper wheel (25 cm diameter) spinning at wheel surface speeds (X-axis) of 16, 19, 22, 25, and 28 m/s. The values H_{ci} in kOe are represented by diamond shaped data points, the values of Bᵣ with square data points, and the values of (BH)ₘₐₓ with filled circles. The horizontal lines crossing the graph from the Y-axis represent the corresponding magnetic properties of an over quenched and optimally annealed Ce_{16.7}Fe_{77.8}B_{5.6} (Sample A in Table I).

FIG. 6 presents Cu Ka x-ray diffraction patterns of annealed Ce₃Fe₁₄₋ₓCoₓB melt-spun ribbon particles for values of x=0, 1, 2, 3, and 4. The major peaks of the secondary Ce(Fe,Co)₂ phase are indicated by open circles. An elemental iron phase (indicated by a dark-filled diamond peak) begins to appear at x=4.

FIG. 7 presents graphs of the refined lattice constants (a, b) of the tetragonal Ce₂Fe₁₄₋ₓCoₓB phase in the x≦5 samples of the Ce₃Fe₁₄₋ₓCoₓB (filled symbols) and Ce_{2.55}Fe₁₄₋ₓCoₓB_{1.27} (open symbols) starting alloy compositions. The lines are linear fits to both sets of data: a (angstroms)=8.7574−0.0058x; b (angstroms)=12.1225−0.0181x.

FIG. 8 presents Cu Kα x-ray diffraction patterns of annealed Ce₃Fe₁₄₋ₓCoₓB melt-spun ribbon particles for values of 5≦x≦14. Ce(Fe,Co)₂ (o), Ce₂(Fe,Co)₁₇ (A), and elemental Fe (dark-diamond) are major secondary phases for x=5, 6, 8, while the x=14 material is almost exclusively CeCo₅ (*).

FIGS. 9(a)-9(c) are graphs of remanence Bᵣ, intrinsic coercivity H_{ci}, and energy product (BH)ₘₐₓ for annealed melt-spun Ce₃Fe₁₄₋ₓCoₓB (FIG. 9(a)) and Ce_{2.55}Fe₁₄₋ₓCoₓB_{1.27} (FIG. 9(b)) alloys; Curie temperature Tc for both series (FIG. 9(c)).

### DESCRIPTION OF PREFERRED EMBODIMENTS

While the intrinsic magnetic properties of Ce₂Fe₁₄B (saturation magnetization 4πMₛ=11.7 kG and anisotropy field Hₐ=26 kOe at 295K, Curie temperature T_{c}=424K) are inferior to those of Nd₂Fe₁₄B (4πMₛ=16 kG, Hₐ=73 kOe, T_{c}=585K), they are nevertheless sufficient to offer the potential for producing Ce—Fe—B magnets having hard magnet characteristics intermediate between those of ferrites and Nd—Fe—B.

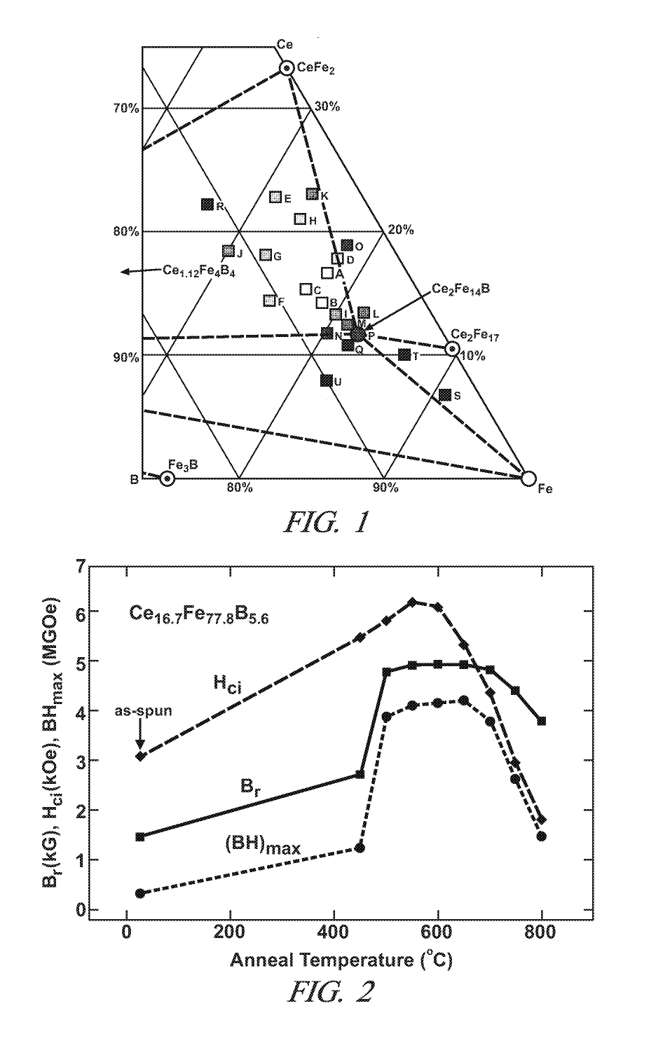

Since the Ce—Fe—B phase diagram (a section of which is illustrated in FIG. 1) is distinct from that of Nd—Fe—B in several respects, featuring in particular the compound CeFe₂ having no Nd analog under normal conditions, it was anticipated that the Ce—Fe—B composition yielding the most favorable hard magnet properties via rapid solidification might well differ from the optimum composition for Nd—Fe—B. Accordingly, a range of compositions was explored that is indicated by the squares in the section of the Ce—Fe—B phase diagram near the Fe vertex shown in FIG. 1 and detailed in Table I.

Ingots of Ce—Fe—B of various compositions were made by induction melting essentially pure portions of the elements. Small ribbon fragments of Ce—Fe—B were melt-spun by induction melting pieces of ingot in a quartz crucible under an argon inert gas atmosphere and ejecting the molten alloy through a 0.6 mm diameter orifice onto the circumferential surface of a chromium-plated copper wheel (25.4 cm diameter) spinning at a wheel surface speed, vₛ, of 35 m/s. The molten stream is rapidly solidified as it hits the spinning quench wheel and ribbon fragments are thrown from the wheel and collected while still in the protective argon atmosphere. This wheel speed, vₛ, corresponds to a quench rate large enough to yield “overquenched” as-spun ribbon fragments that are mostly amorphous or nanocrystalline. A portion of the collected ribbon product was ground to a coarse powder in a SPEX 8000 High Energy Ball Mill (HEBM) by milling for 2 minutes in an argon atmosphere. X-ray diffraction (XRD) of the as-quenched powder showed a superposition of peaks from nanocrystalline material together with very broad peaks of an amorphous powder diffraction pattern.

Powdered ribbons were heat treated using a Perkin-Elmer, System 7 thermogravimetric analyzer (TGA). The ribbons were heated at 100° C./min under flowing argon to a target temperature, held at temperature for 5 min, and then cooled at 100° C./min back to room temperature. No significant weight changes occurred during heat treatment. The target temperature was varied between 450° C. and 800° C. to determine the temperature, Tₐ, at which the remanence Bᵣ, intrinsic coercivity H_{ci}, and energy product (BHₘₐₓ) are maximized. Requiring only that the quench rate (i.e., vₛ to a first approximation) exceed a minimum value to produce largely amorphous material, this procedure is an alternative to identifying the best vₛ for each composition; it was originally established many years ago for melt-spun Nd—Fe—B. Identifying a best vₛ for molten CeₐFe_{b}B_{c} alloys is demonstrated below in this specification.

Magnetic properties of the heat treated ribbons were measured on a PAR model 155 vibrating sample magnetometer (VSM). Crushed powder was loaded into a KEL-F sample holder, and then fully magnetized by a pulsed magnetic field. Demagnetization curves were measured to a maximum reverse field of 18.9 kOe.

The variation in magnetic properties with composition is summarized in the following Table I.

TABLE I

| | | Tₐ | Bᵣ | H_{ci} | (BH)ₘₐₓ | |
|---|---|---|---|---|---|---|
| Composition | | (° C.) | (kG) | (kOe) | (MGOe) | Bᵣ + H_{ci} |
| Ce_{16.7}Fe_{77.8}B_{5.6} | (A) | 550 | 4.92 | 6.18 | 4.12 | 11.10 |
| Ce_{14.3}Fe_{78.6}B_{7.1} | (B) | 500 | 5.33 | 5.43 | 4.59 | 10.76 |
| Ce_{15.4}Fe_{76.9}B_{7.7} | (C) | 600 | 4.68 | 5.77 | 3.43 | 10.46 |
| Ce_{17.9}Fe_{77.9}B_{4.2} | (D) | 600 | 4.59 | 5.60 | 3.30 | 10.19 |
| Ce_{22.8}Fe_{71.1}B_{6.1} | (E) | 600 | 2.87 | 7.09 | 1.39 | 9.96 |
| Ce_{14.4}Fe_{74.9}B_{10.7} | (F) | 600 | 4.99 | 4.67 | 3.64 | 9.66 |
| Ce_{18.2}Fe_{72.7}B_{9.1} | (G) | 500 | 3.15 | 6.42 | 1.64 | 9.57 |
| Ce_{21.1}Fe_{73.7}B_{5.3} | (H) | 600 | 3.19 | 6.27 | 1.52 | 9.47 |
| Ce_{13.3}Fe_{80.0}B_{6.7} | (I) | 600 | 5.21 | 3.19 | 2.79 | 8.40 |
| Ce_{18.5}Fe_{70.0}B_{11.5} | (J) | 600 | 3.46 | 4.87 | 1.69 | 8.34 |
| Ce_{23.1}Fe_{73.5}B_{3.4} | (K) | 600 | 2.87 | 5.40 | 1.10 | 8.26 |
| Ce_{13.5}Fe_{81.9}B_{4.7} | (L) | 650 | 4.78 | 3.13 | 2.52 | 7.91 |
| Ce_{12.5}Fe_{81.3}B_{6.3} | (M) | 600 | 5.12 | 2.60 | 2.36 | 7.72 |
| Ce_{11.8}Fe_{80.2}B_{8.0} | (N) | 600 | 3.88 | 2.84 | 1.64 | 6.72 |
| Ce_{18.9}Fe_{78.0}B_{3.1} | (O) | 700 | 2.63 | 3.95 | 1.06 | 6.57 |
| Ce_{11.8}Fe_{82.4}B_{5.9} | (P) | 700 | 4.52 | 1.65 | 1.46 | 6.17 |
| Ce_{10.9}Fe_{82.1}B_{7.0} | (Q) | 700 | 4.17 | 1.39 | 1.18 | 5.56 |
| Ce_{22.2}Fe_{66.7}B_{11.1} | (R) | 800 | 2.04 | 3.31 | 0.66 | 5.35 |
| Ce_{6.8}Fe_{90.9}B_{2.3} | (S) | 700 | 3.23 | 0.65 | 0.45 | 3.88 |
| Ce_{10.1}Fe_{86.4}B_{3.5} | (T) | 700 | 2.59 | 0.83 | 0.41 | 3.42 |
| Ce_{8.0}Fe_{82.11}B_{10.0} | (U) | 700 | 2.30 | 0.60 | 0.30 | 2.90 |

FIG. 2 illustrates the development of Bᵣ, H_{ci}, and (BH)ₘₐₓ with anneal temperature for the Ce_{16.7}Fe_{77.8}B_{5.6} composition of Table I. All three quantities do not grow appreciably from their as-spun values until ˜450° C., at which point large scale crystallization begins as x-ray diffraction (XRD) clearly shows. FIG. 2 is qualitatively representative of all the results inasmuch as the properties are collectively maximal at either a single anneal temperature Tₐ or, in a few cases, over a narrow temperature interval. While Tₐ=600° C. for half of the samples in Table I, the variation of optimal Tₐ with composition is considerable.

It is also evident from Table I that the maximum values of the three magnetic properties do not occur for a unique composition: among the formulations we prepared Bᵣ and (BH)ₘₐₓ are largest for Ce_{14.3}Fe_{78.6}B_{7.1} (composition B), while H_{ci} peaks for the substantially Ce-richer composition Ce_{22.8}Fe_{71.1}B_{6.1} (E). To organize the results in a way that emphasizes remanence and coercivity equally, certainly justifiable from a technological perspective, we use their sum as a convenient and practical, although arbitrary, figure of merit. The entries in Table I are given in order of decreasing (Bᵣ+H_{ci}), and the squares in FIG. 1 are shaded on a gray scale for that quantity varying from filled/black (smallest) to unfilled/white (largest). On this basis Ce_{16.7}Fe_{77.8}B_{5.6} (A) is the single composition yielding the best overall performance while the squares A, B, and C in FIG. 1 demarcate the region of most favorable compositions. As is the case for Nd—Fe—B, the stoichiometric Ce₂Fe₁₄B composition [Ce_{11.8}Fe_{82.4}B_{5.9} (P) in Table I] leads to inferior Bᵣ and markedly reduced H_{ci} when compared with the best results; this is likely a consequence of insufficient intergranular material in the heat treated ribbons to inhibit domain wall motion.

By means of time-temperature observations of thermal arrest during the cooling of several melted ingots (A, D, G, O, T in Table I) roughly spanning our composition region, we determined that the Ce—Fe—B liquidus is in the narrow 1041° C. 1056° C. interval (substantially smaller than the 90° C. excursion of melting points for the same Ce/Fe ratio range in the Ce-Fe phase diagram, illustrating one profound effect of boron). Since the melt temperature in almost all of our spins (A-F, H-K, M-P, R in Table I) was 1300° C., the difference between it and the liquidus was essentially independent of stoichiometry, hence it can be inferred that composition rather than quenching regimen is the primary factor controlling the magnetics.

We emphasize that the Ce_{16.7}Fe_{77.8}B_{5.6} (A) composition yields properties superior to those of Ce_{13.5}Fe_{81.9}B_{4.7} (L), the Ce—Fe—B analog of the optimum Nd—Fe—B composition. In FIG. 1, square A is located in the triangle formed by CeFe₂ and the two ternaries Ce₂Fe₁₄B and Ce_{1.12}Fe₄B₄ while L resides on the other side of the CeFe₂—Ce₂Fe₁₄B tie line in the CeFe₂—Ce₂Fe₁₄B—Ce₂Fe₁₇ triangle having two Ce-Fe binary vertices. R₂Fe₁₇ (R rare earth) is the only binary R—Fe compound common to the Ce—Fe—B and Nd—Fe—B phase diagrams, each of which contains two R—Fe phases: the second is CeFe₂ in the former and Nd₅Fe₁₇ in the latter. Nd_{13.5}Fe_{81.9}B_{4.7} resides within the triangle formed by Nd₂Fe₁₇, Nd₂Fe₁₄B, and Nd₅Fe₁₇ instead of RFe₂. With the caveat that inferences based on the equilibrium phase structure may not necessarily apply to rapidly quenched materials, the presence of Nd₅Fe₁₇ (Nd_{22.7}Fe_{77.3}), substantially richer in Fe than RFe₂ (R_{33.3}Fe_{66.7}), is evidently linked to the fact that the optimum Nd—Fe—B formulation R_{13.5}Fe_{81.9}B_{4.7} is also Fe richer than the optimum Ce—Fe—B composition R_{16.7}Fe_{77.8}B_{5.6} and thus in closer proximity to R₂Fe₁₄B. Moreover, in optimized Nd_{13.5}Fe_{81.9}B_{4.7} the only secondary component is an intergranular Nd—Fe binary alloy, in qualitative agreement with its position in the Nd—Fe—B phase diagram.

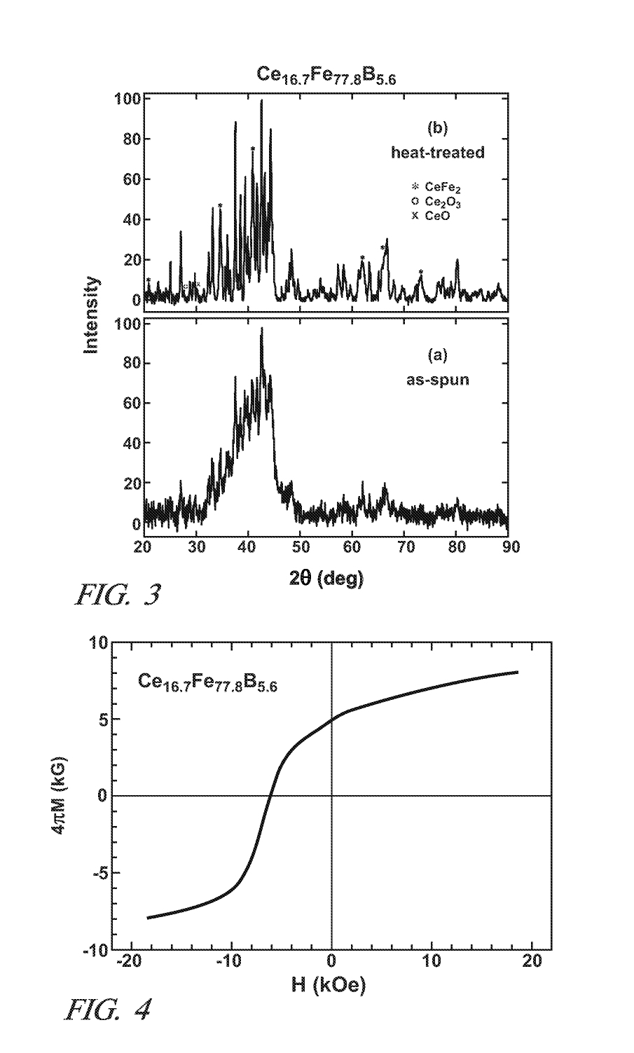

XRD patterns for Ce_{16.7}Fe_{77.8}B_{5.6} (A) are displayed in FIG. 3. The as-spun material [FIG. 3 (a)] is comprised of a substantial amorphous component as well as nanocrystalline Ce₂Fe₁₄B and CeFe₂. On heat treatment above 450° C. full crystallinity develops [FIG. 3 (b)]; the principal lines are those of Ce₂Fe₁₄B with clear evidence for an appreciable CeFe₂ fraction and minor contamination by Ce₂O₃ and CeO. Given the location of sample A in FIG. 1 we can determine the phase fractions in equilibrium:

Ce_{16.7}Fe_{77.8}B_{5.6}=0.746 Ce_{11.8}Fe_{82.4}B_{5.9}+0.227 Ce_{33.3}Fe_{66.7}+0.027 Ce_{12.3}Fe_{43.9}B_{43.95}

where Ce_{11.8}Fe_{82.4}B_{5.9}, Ce_{33.3}Fe_{66.7}, and Ce_{12.3}Fe_{43.9}B_{43.9} respectively represent the phases Ce₂Fe₁₄B, CeFe₂, and Ce_{1.12}Fe₄B₄ normalized to 100 atoms per phase to be consistent with the notation for the starting composition, Ce_{16.7}Fe_{77.8}B_{5.6} on the left side. The relatively small coefficient of Ce_{12.3}Fe_{43.9}B_{43.9}may be responsible for its lack of an x-ray signature in FIG. 3 (b); it is also possible that the phase is amorphous even after heat treatment and cannot be distinguished from background or that the non-equilibrium processing suppresses its formation. But, it turns out that the microstructural constituents of these melt-spun and annealed compositions, A through U are apparently not in equilibrium.

X-ray or neutron powder diffraction data can provide information on many characteristics of crystalline materials, such as lattice constants, atomic positions, and preferred orientation of crystallites. The Rietveld refinement method [H. M. Rietveld, Journal of Applied Crystallography, Volume 2 (1969), page 65] is a powerful, very widely used tool for analyzing powder diffraction data. It relies on a least squares approach to refine a calculated powder pattern until it corresponds to the measured pattern. The technique can treat strongly overlapping reflections, allowing for greater accuracy and distinguishing it from predecessor methods. In a sample with more than one constituent (e. g., Ce₂Fe₁₄B and CeFe₂ of interest here), multicomponent Rietveld refinement of the diffraction data affords an estimate of the amounts of the constituents.

A multi-component Rietveld analysis of the x-ray diffraction data in FIG. 3 (b) (as opposed to the estimate in paragraph [0036] based on the assumption of equilibrium phases) yields better Ce₂Fe₁₄B and CeFe₂ mass fraction estimates of ˜80% and ˜20%, respectively, with only a small trace of oxide. Using densities ρ(Ce₂Fe₁₄B)=7.7 g/cm³ and ρ(CeFe₂)=8.6 g/cm³ leads to corresponding volume fractions of ˜82% and ˜18%.

Ce₂Fe₁₄B is the only species present that is magnetic at room temperature, thus the remanence of an isotropic magnet comprising ˜82 vol % uniaxial Ce₂Fe₁₄B having 4πMₛ=11.7 kG can be estimated as Bᵣ˜0.82×0.5×11.7 kG=4.80 kG, in good agreement with our measured value of 4.92 kG. Analysis of the line widths affords estimates of ˜60 nm and ˜20 nm for average Ce₂Fe₁₄B and CeFe₂ grain sizes, respectively. We note that Bᵣ=5.33 kG for the Ce_{14.3}Fe_{78.6}B_{7.1}(B) sample in Table I implies a Ce₂Fe₁₄B mass or volume fraction larger than that for sample A, but at the expense of coercivity.

A multi-component Rietveld analysis of an x-ray diffraction pattern for Ce_{14.3}Fe_{78.6}B_{7.1}, composition (B), indicated a mass fraction of 94% of the Ce₂Fe₁₄B phase, a mass fraction of about 4% of the CeFe₂ phase, and of a mass fraction of about 1% iron. A like analysis of an x-ray diffraction pattern for Ce_{15.4}Fe_{76.9}B_{7.7}, composition (C), indicated a mass fraction of 86% of the Ce₂Fe₁₄B phase and a mass fraction of about 14% of the CeFe₂ phase.

In optimized Nd—Fe—B, the Nd₂Fe₁₄B volume fraction is 95% and the average grain size is 30 nm. Moreover, the only secondary component is an intergranular Nd˜Fe binary alloy. The differences in overall composition and secondary phase occurrence between optimized melt-spun Ce—Fe—B and Nd—Fe—B are consequences of the contrast between the Ce—Fe—B and Nd—Fe—B phase diagrams, as discussed in paragraph [0027]. In turn, that contrast is due at least in part to the fact that the Nd ion is trivalent while the Ce ion is tetravalent when combined with Fe and B; the distinct bond character that results from the different number of valence electrons affects the stoichiometry and number of the compounds that form.

FIG. 4 shows the demagnetization curve for the Ce_{16.7}Fe_{77.8}B_{5.6} (A) sample measured in a ±19 kOe applied field range after an initial 90 kOe magnetizing pulse. The curve is typical of a magnet comprised of randomly oriented material. The small kink near 1 kOe reverse field arises from a minor fraction of large Ce₂Fe₁₄B grains having low coercivity.

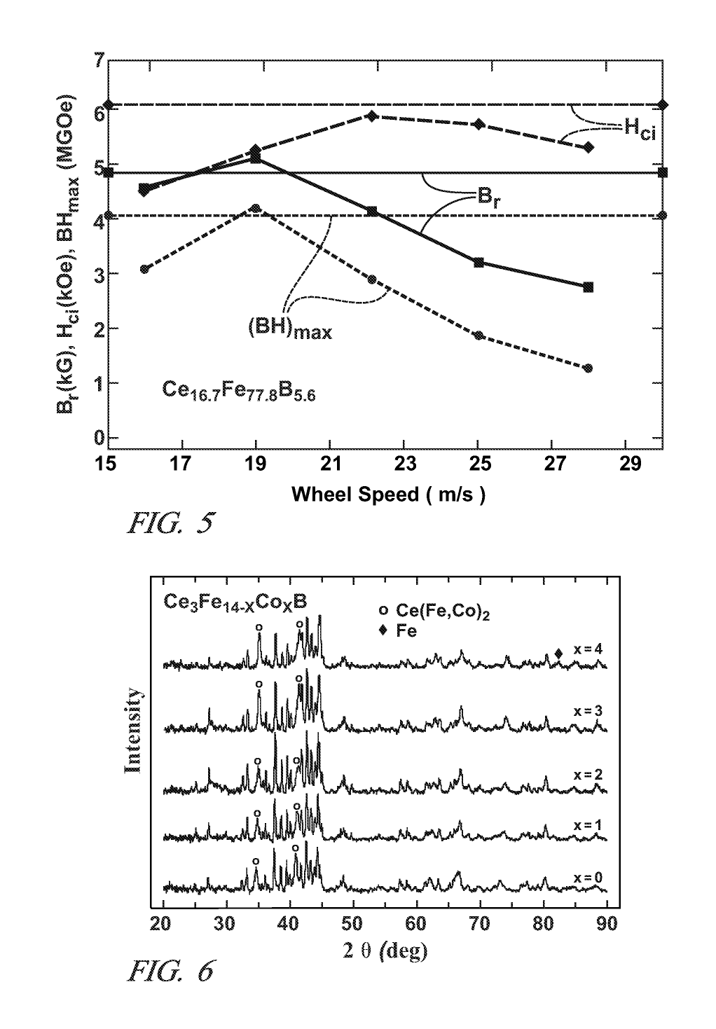

In the practices of the invention described above in this specification, the melt of the selected CeₐFe_{b}B_{c} composition was over-quenched and then optimally annealed to obtain good permanent magnet properties. In another practice of the invention portions of the CeₐFe_{b}B_{c} starting ingot are melt-spun using varying quench wheel speeds to determine a quench rate that directly yields a melt-spun product with permanent magnet properties. For example, a melt of the above specified Ce_{16.7}Fe_{77.8}B_{5.6} (A) composition was prepared in a quartz crucible and portions of the molten alloy were ejected through a 0.6 mm diameter onto the circumferential surface of the chromium-plated copper wheel (25 cm diameter). Fragments of melt-spun Ce_{16.7}Fe_{77.8}13_{5.6} composition were obtained using wheel surface speeds of 16 m/s, 19 m/s, 22 m/s, 25 m/s, and 28 m/s. The melt-spun fragments were ball milled as-is (no anneal) and their magnetic properties determined. This data is presented in the following Table II and graphically in FIG. 5.

TABLE II

| Wheel | | | | |
|---|---|---|---|---|
| speed | Bᵣ | H_{ci} | (BH)ₘₐₓ | |
| (m/s) | (kG) | (kOe) | (MGOe) | H_{ci} + Bᵣ |
| 16 | 4.63 | 4.53 | 3.14 | 9.16 |
| 19 | 5.19 | 5.32 | 4.27 | 10.52 |
| 22 | 4.25 | 5.96 | 2.99 | 10.20 |
| 25 | 3.28 | 5.80 | 1.90 | 9.08 |
| 28 | 2.82 | 5.37 | 1.30 | 8.19 |

FIG. 5 is a graphical presentation of the data in Table II. The varying magnetic properties of the five melts of Ce_{16.7}Fe_{77.8}B_{5.6} composition are presented on the Y-axis with the quench wheel speed presented on the X-axis. Values H_{ci} in kOe are represented by diamond shaped data points, the values of Bᵣ with square data points, and the values of (BH)ₘₐₓ with filled circles. The horizontal lines crossing the graph from the Y-axis (using the same symbols for the data) represent the corresponding magnetic properties of an over quenched and optimally annealed Ce_{16.7}Fe_{77.8}B_{5.6} (Sample A in Table I).

In the examples described above in this specification the chromium-coated copper quench wheel was relatively massive compared to the volumes of liquid cerium-iron-boron alloys being quenched. It was initially at room temperature and it did not require cooling. However, in the melt spinning and quenching of larger volumes of such molten alloys it may be necessary to provide for cooling or other temperature control of the quench wheel.

Thus, we have identified the region of the Ce—Fe—B phase diagram from which materials primarily comprised of Ce₂Fe₁₄B and having optimum hard magnet properties can be synthesized by melt spinning Preferably a composition is initially quenched to an amorphous condition and then annealed at a selected temperature to obtain suitable grain size and microstructural proportions of the Ce₂Fe₁₄B phase and secondary phases. As is generally the case for melt-spun magnets, the composition may be varied to improve Bᵣ and (BH)ₘₐₓ at the sacrifice of H_{ci}, and vice versa. Bᵣ and H_{ci} values that are ˜46% of 4πMₛ (50% is the upper limit for an isotropic uniaxial magnet) and ˜27% of Hₐ, respectively, have been achieved in heat treated ribbons. By these metrics the results are quite comparable to those well established for Nd—Fe—B.

A disadvantage of Ce₂Fe₁₄B is that its Curie temperature Tc of about 425 K (152° C.) is too low for some industrial applications. Here we explore cobalt substitution for iron in Composition A of Table I (Ce_{16.7}Fe_{77.8}B_{5.6} or, equivalently, Ce₃Fe₁₄B) and in Composition B of Table I (Ce_{14.3}Fe_{78.6}B_{7.1} or, equivalently, Ce_{2.55}Fe₁₄B_{1.27}) to increase T_{c} and to assess the impact of compositional variation.

Alloys of the form Ce₃Fe₁₄₋ₓCoₓB (A) and Ce_{2.55}Fe₁₄₋ₓCoₓB_{1.27} (B) were prepared by melting high-purity starting elements in an induction furnace. Samples of each composition were prepared in which the cobalt content was varied by integral values of x from one to fourteen. The resulting ingots were then melt spun by induction melting several ingot pieces (˜15 g total) in a quartz crucible and ejecting the melt through a 0.6 mm orifice onto a rotating Cr-plated Cu wheel (25.4 cm diameter, 35 m/s surface speed) to produce over-quenched ribbon particles. The as-spun ribbon particles were reduced to powder particles by high energy ball milling for 2 minutes and then annealed for 5 minutes at 600° C. All processing steps were conducted in an Ar atmosphere to prevent oxidation.

Phase purity was evaluated on powdered samples using a Bruker D8 Advance DaVinci X-ray diffractometer (Cu K_{α}, radiation, λ=0.154 nm). Multicomponent Rietveld refinement was used to determine the lattice parameters of Ce₂Fe₁₄₋ₓCoₓB from the experimental X-ray diffraction patterns. The room temperature Bᵣ, H_{ci}, and (BH)ₘₐₓ were measured using a vibrating sample magnetometer (VSM). Powdered samples fixed in threaded poly(chlorotrifluoroethylene), PCTFE, holders were used for the VSM measurements. The Curie temperature (T_{c}) was measured using thermogravimetric analysis with a constant magnetic field applied to the sample.

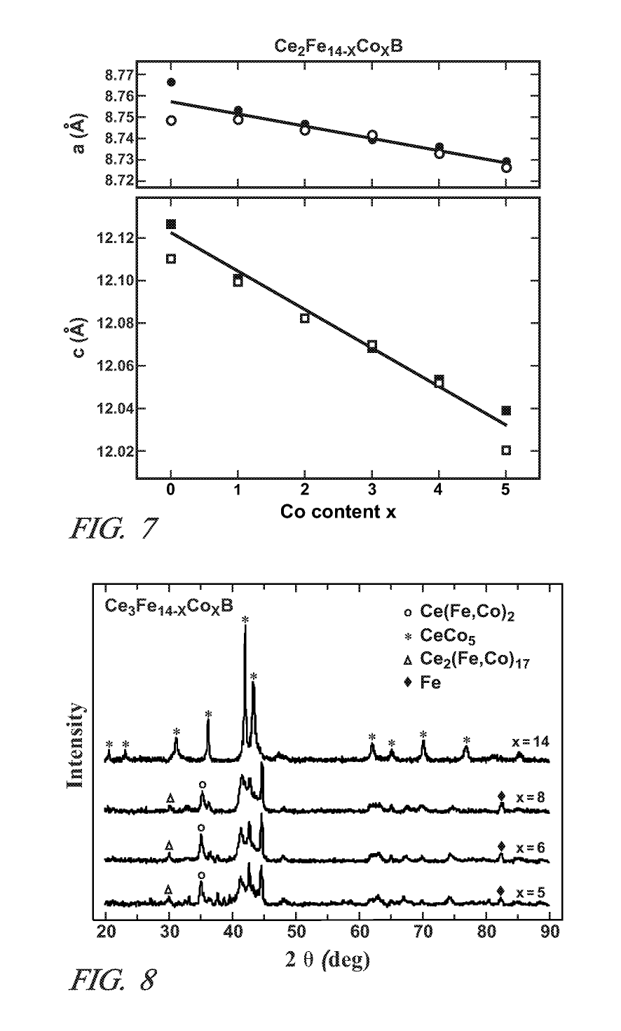

In the as-spun state, the materials consist of amorphous and nanocrystalline components; onset of crystallization for the Ce₂(Fe,Co)₁₄B phase occurs at approximately 500° C. X-ray diffraction (XRD) patterns of annealed Ce₃Fe₁₄₋ₓCoₓB (x≦4) ribbons (Composition A) are shown in FIG. 6. While the principal lines in each case correspond to Ce₂Fe_{14—}CoₓB, there is an appreciable fraction of Ce(Fe,Co)₂, as noted previously for the Co-free Ce₃Fe₁₄B composition; and, some elemental Fe begins to appear for x=4. XRD diagrams for the Ce_{2.55}Fe₁₄₋ₓCoₓB_{1.27} (x≦4) series (Composition B) are similar except that Ce(Fe,Co)₂ is first noticeable at x=3. The x-ray peaks corresponding to Ce₂Fe₁₄₋ₓCOₓB shift to slightly higher 20 values with increasing x due to the smaller atomic radius of Co relative to Fe, which causes the lattice to contract and indicates that Co successfully substitutes for Fe in the structure. The refined lattice constants of the samples in which Ce₂Fe₁₄₋ₓCoₓB is the majority phase (x≦5) are plotted in FIG. 7 and listed in Table III. As the table indicates, our results for Ce₂Fe₁₄B (x=0) are in good agreement with literature values. Both a and c trend lower with increasing x, with c decreasing approximately 3 times faster than a as shown by the different slopes of the linear approximations to the data (FIG. 7). Consequently, the c/a ratio also decreases with increasing x (Table III).

TABLE III

| | |
|---|---|
| Ce₃Fe₁₄₋ₓCoₓB | Ce_{2.55}Fe₁₄₋ₓCoₓB_{1.27} |

| x | a (Å) | c (Å) | c/a | a (Å) | c (Å) | c/a |
|---|---|---|---|---|---|---|
| 0 | 8.767 | 12.126 | 1.383 | 8.749 | 12.110 | 1.384 |
| | 8.77 | 12.15 | 1.385 | | | |
| | 8.750 | 12.090 | 1.382 | | | |
| 1 | 8.754 | 12.101 | 1.382 | 8.749 | 12.099 | 1.383 |
| 2 | 8.747 | 12.082 | 1.381 | 8.744 | 12.082 | 1.382 |
| 3 | 8.739 | 12.069 | 1.381 | 8.742 | 12.069 | 1.381 |
| 4 | 8.736 | 12.053 | 1.380 | 8.733 | 12.052 | 1.380 |
| 5 | 8.730 | 12.039 | 1.379 | 8.727 | 12.020 | 1.377 |

As the Co content increases from x=5 the Ce₂Fe₁₄,CoₓB component diminishes precipitously; the XRD patterns in FIG. 8 make this clear for the Ce₃Fe₁₄₋ₓCoₓB starting alloy series. At x=5, 6, 8 Ce₂(Fe,Co)₁₇ appears as a secondary phase in addition to Ce(Fe,Co)₂, and the x=14 material is almost exclusively comprised of CeCo₅ with no vestige of Ce₂Co₁₄B. Results for the Ce_{2.55}Fe₁₄₋ₓCOₓB_{1.27} series are qualitatively similar: the Ce₂Fe₁₄B-type structure predominates until x=5 (36 at % Co replacing Fe), at which point it begins to deteriorate into other phases. We find no evidence, either experimentally or in the literature, of a compound corresponding to Ce₂Co₁₄B, which is likely why Co has limited solubility in Ce₂Fe₁₄B, in contrast to other R₂Fe₁₄B compounds for which R₂(Fe₁₋ₓCoₓ)₁₄B forms for all Co concentrations.

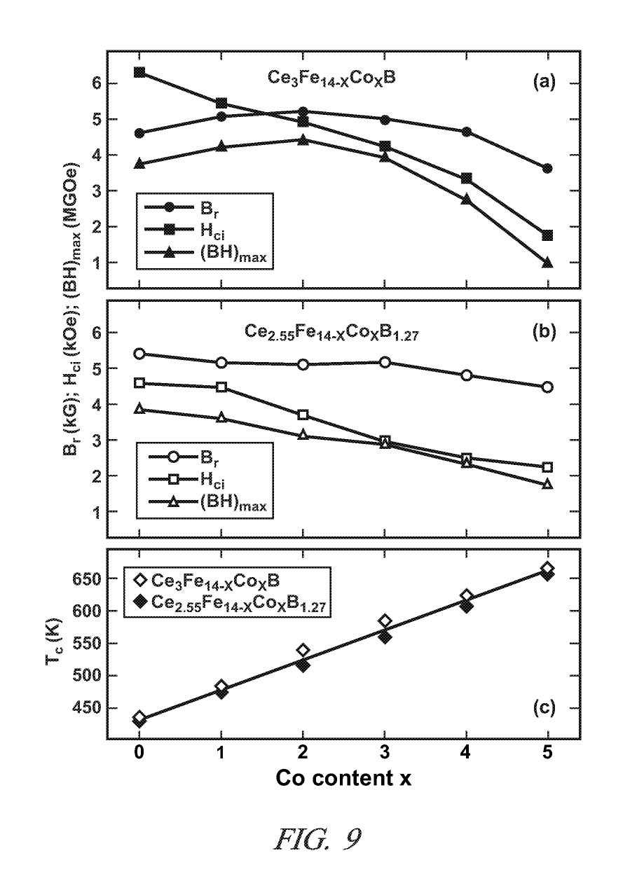

Table IV and FIG. 9 present the compositional dependence of the hard magnetic properties for both alloy series over the 0≦x≦5 interval in which the primary phase is Ce₂Fe₁₄B-type. The intrinsic coercivity H_{ci} is larger in the Ce₃Fe₁₄₋ₓCoₓB starting alloy series except for x=5, but in both cases it decreases monotonically with x. This behavior reflects reduction of the uniaxial magnetocrystalline anisotropy as occurs in other R₂Fe₁₄B compounds in which Co substitution for Fe is known to foster basal plane moment alignment. While the values of the remanence Bᵣ are comparable in both alloy groups, there is more pronounced excursion with x in the Ce₃Fe₁₄₋ₓCoₓB series, in which Bᵣ maximizes at x=2 and decreases uniformly with lower and higher Co content. The energy product for that series displays the same overall variation with x (cf. FIG. 9(a) especially), and (BH)ₘₐₓ 4.4 MGOe for x=2 is the largest value we have obtained.

TABLE IV

| | Bᵣ (kG) | | H_{ci} (kOe) | | (BH)ₘₐₓ (MGOe) | | T_{c} (K) | |
|---|---|---|---|---|---|---|---|---|
| | Se- | Se- | Se- | Se- | Se- | Se- | Se- | Se- |
| x | ries A | ries B | ries A | ries B | ries A | ries B | ries A | ries B |
| 0 | 4.6 | 5.4 | 6.3 | 4.6 | 3.7 | 3.8 | 429 | 433 |
| 1 | 5.1 | 5.1 | 5.4 | 4.5 | 4.2 | 3.6 | 474 | 484 |
| 2 | 5.2 | 5.1 | 4.9 | 3.7 | 4.4 | 3.1 | 516 | 539 |
| 3 | 5.0 | 5.2 | 4.2 | 2.9 | 3.9 | 2.8 | 560 | 585 |
| 4 | 4.7 | 4.8 | 3.3 | 2.5 | 2.7 | 2.3 | 607 | 624 |
| 5 | 3.6 | 4.5 | 1.7 | 2.2 | 0.9 | 1.7 | 658 | 666 |

In the 0≦x≦5 range the Curie temperature increases almost linearly with x, as FIG. 9(c) clearly indicates. For the x=5 samples T_{c}˜660 K is more than 50% higher than for x=0, representing a rate of increase similar to that reported for the Nd₂Fe₁₄₋ₓCoₓB and Pr₂Fe₁₄₋ₓCoₓB systems. The x=2 material of the Ce₃Fe₁₄₋ₓCoₓB starting alloy series is particularly interesting from the technological perspective since it is characterized by a T_{c} that is ˜90 K larger than for x=0 with improved values of Bᵣ and (BH)ₘₐₓ as well. The loss in coercivity might be ameliorated by small substitutions of rare earths such as Pr, Nd, Tb, and/or Dy for Ce. Table V presents the results of Rietveld analyses on the annealed samples of the Ce₃Fe₁₄₋ₓCoₓB starting alloy series for 0≦x≦5.

TABLE V
Phase fractions from Rietveld fits to x-ray data for Ce₃Fe₁₄₋ₓCoₓB

| | Ce₂(Fe₁₄₋ₓCoₓ)B | Ce(Fe,Co)₂ | Ce₂(Fe,Co)₁₇ | Fe |
|---|---|---|---|---|
| x | mass % | mass % | mass % | mass % |
| 0 | 80 | 20 | | |
| 1 | 84 | 16 | | |
| 2 | 86 | 14 | | 1 |
| 3 | 77 | 20 | | 4 |
| 4 | 66 | 19 | 7 | 8 |
| 5 | 35 | 30 | 16 | 19 |

We have demonstrated that substituting Co for Fe is an effective method of increasing the Curie temperature of Ce₂Fe₁₄B Annealed powder melt spun from either the Ce₃Fe₁₄₋ₓCoₓB or Ce_{2.55}Fe₁₄₋ₓCoₓB_{1.27} starting compositions maintains the tetragonal Ce₂Fe₁₄B structure for x≦5, but that phase progressively diminishes for x>5. T_{c} increases rapidly with increasing x, reaching ˜660 K for x=5. The x=2 initial composition Ce₃Fe₁₂Co₂B offers technologically significant improvement in T_{c}, Bᵣ, and (BH)ₘₐₓ at the expense of only modest H_{ci} loss.

Certain practices of the invention have been presented for the purpose of illustration and not for the purpose of limiting the scope of the invention.

1. A method of making a permanent magnet composition comprising:
preparing a melt consisting essentially of the elements cerium, iron, and boron, the melt being under a non-oxidizing atmosphere;
forming rapidly solidified, amorphous or nano-crystalline particles of the cerium-iron-boron composition from the melt, such particles having properties of a soft magnetic material;
annealing the soft magnetic material at a temperature above about 450° C. for a time to form a crystalline material having permanent magnet properties, the crystalline material comprising at least seventy percent by mass of the compound Ce₂Fe₁₄B and the balance comprised of secondary phases, each secondary phase containing one or more of cerium, iron, and boron.

2. A method of making a permanent magnet composition as recited in claim 1 in which cobalt is substituted for a portion of the iron for the purpose of increasing the Curie temperature of the permanent magnet composition.

3. A method of making a permanent magnet composition as recited in claim 1 in which the temperature and duration of the anneal are controlled to additionally provide the crystalline material with values of intrinsic coercivity, H_{ci} in kOe, and remanence, Bᵣ in kG, where the numerical sum of H_{ci} and Bᵣ is 10 or greater.

4. A method of making a permanent magnet composition as recited in claim 1 in which the permanent magnet composition is a composition selected from the group consisting of Ce_{16.7}Fe_{77.8}B_{5.6}, Ce_{14.3}Fe_{78.6}B_{7.1}, and Ce_{15.4}Fe_{76.9}B_{7.7}.

5. A method of making a permanent magnet composition as recited in claim 1 in which the annealed permanent magnet material comprises at least one of Ce(Fe)₂, Ce₂(Fe)₁₇, and iron as a secondary phase.

6. A method of making a permanent magnet composition comprising:
preparing a melt consisting essentially of the elements cerium, iron, cobalt, and boron, the melt being under a non-oxidizing atmosphere;
forming rapidly solidified, amorphous or nano-crystalline particles of the cerium-iron-cobalt-boron composition from the melt, such particles having properties of a soft magnetic material;
annealing the soft magnetic material at a temperature above about 450° C. for a time to form a crystalline material having permanent magnet properties, the crystalline material comprising at least seventy percent by mass of the compound Ce₂(Fe₁₄₋ₓ,Coₓ)B, where x is in the range from about 1 to about 5, and the balance comprised of secondary phases, each secondary phase containing one or more of cerium, iron, cobalt, and boron.

7. A method of making a permanent magnet composition as recited in claim 6 in which the temperature and duration of the anneal are controlled to additionally provide the crystalline material with values of intrinsic coercivity, H_{ci} in kOe, and remanence, Bᵣ in kG, where the numerical sum of H_{ci} and Bᵣ is 10 or greater.

8. A method of making a permanent magnet composition as recited in claim 6 in which the permanent magnet composition in which the cobalt is included in a composition selected from the group consisting of Ce_{16.7}(Fe_{1-y}Co_{y})_{77.8}B5.6, Ce14.3(Fe_{1-y}Co_{y})_{78.6}B_{7.1}, and Ce_{15.4}(Fe_{1-y}Co_{y})_{76.9}B_{7.7}, where y is in the range from about 0.07 to about 0.36.

9. A method of making a permanent magnet composition as recited in claim 6 in which the annealed permanent magnet material comprises at least one of Ce(Fe,Co)₂, Ce₂(Fe,Co)₁₇, cobalt, iron, and cobalt-iron alloy as a secondary phase.

10. A permanent magnet composition when produced by rapidly-solidifying a liquid mixture consisting essentially of cerium, iron and boron and annealing the solidified mixture to form a crystalline material consisting essentially of at least seventy percent by mass of the compound Ce₂Fe₁₄B and the balance secondary phases, each secondary phase comprising one or more of cerium, iron, and boron.

11. A permanent magnet material as recited in claim 10 in which cobalt is substituted for a portion of the iron for the purpose of increasing the Curie temperature of the permanent magnet material.

12. A permanent magnet material as recited in claim 10 having values of intrinsic coercivity, H_{ci} in kOe, and remanence, Bᵣ in kG, where the numerical sum of H_{ci} and Bᵣ is ten or greater.

13. A permanent magnet material as recited in claim 10 in which the permanent magnet composition is a composition selected from the group consisting of Ce_{16.7}Fe_{77.8}B_{5.6}, Ce_{14.3}Fe_{78.6}B_{7.1}, and Ce_{15.4}Fe_{76.9}B_{7.7}.

14. A permanent magnet material as recited in claim 10 in which the annealed permanent magnet material comprises at least one of Ce(Fe)₂, Ce₂(Fe)₁₇, and iron as a secondary phase.

15. A permanent magnet material as recited in claim 11 in which the annealed permanent magnet material comprises at least one of Ce(Fe,Co)₂, Ce₂(Fe,Co)₁₇, cobalt, iron, and cobalt-iron alloy as a secondary phase.

16. A permanent magnet material as recited in claim 11 in which the permanent magnet composition is one in which the cobalt is included in a composition selected from the group consisting of Ce_{16.7}(Fe_{1-y}Co_{y})_{77.8}B_{5.6}, Ce_{14.3}(Fe_{1-y}Co_{y})_{78.6}B_{7.1}, and Ce_{15.4}(Fe_{1-y}Co_{y})_{76.9}B_{7.7}, where y is in the range from about 0.07 to about 0.36.
